(19) United States
(12) Patent Application Publication
(10) Pub. No.: US 2014/0129327 A1
(43) Pub. Date: May 8, 2014

(54) ADVERTISEMENT DELIVERY DEVICE AND ADVERTISEMENT DELIVERY METHOD

(71) Applicant: YAHOO JAPAN CORPORATION, Tokyo (JP)

(72) Inventor: Takashi TASHIRO, Tokyo (JP)

(73) Assignee: YAHOO JAPAN CORPORATION, Tokyo (JP)

(21) Appl. No.: 14/066,183

(22) Filed: Oct. 29, 2013

(30) Foreign Application Priority Data
Nov. 2, 2012 (JP) 2012-242871

(51) Int. Cl. G06Q 30/02

(52) U.S. Cl. CPC G06Q 30/0251
USPC 705/14.49

(57) ABSTRACT

An advertisement delivery device acquires a value regarding a degree of relevance with content to which advertisement information set to the content is allowed to be delivered when a delivery request of advertisement information to be delivered to content is received, calculates a degree of relevance between the content and the advertisement information, determines whether the calculated degree of relevance is higher than the acquired value regarding the degree of relevance, and delivers the advertisement information as the advertisement information to be delivered to the content when the degree of relevance is determined as being higher than the value regarding the degree of relevance.

### CROSS-REFERENCE TO RELATED APPLICATIONS

The present application claims priority to and incorporates by reference the entire contents of Japanese Patent Application No. 2012-242871 filed in Japan on Nov. 2, 2012.

### BACKGROUND OF THE INVENTION

1. Field of the Invention

The present invention relates to an advertisement delivery device and an advertisement delivery method.

2. Description of the Related Art

In recent years, with the rapid spread of the Internet, advertisement delivery using the Internet has been actively performed. For example, as advertisement delivery, there is a technique in which a text advertisement representing, for example, a company, a product, or the like is displayed at a predetermined position of content (for example, web page), and when the text advertisement is clicked, transition to a web page of an advertiser is performed.

As a technique of selecting an advertisement to be displayed on content as described above, so-called content match advertising of displaying an advertisement according to details of content has been known. For example, in the content match advertising, details of an advertisement is compared with details of content, a degree of relevance representing how much the advertisement is relevant to the content is calculated, and the advertisement is displayed on the content as the advertisement is relevant to the content when the calculated degree of relevance is a predetermined degree of relevance or higher. A value regarding the predetermined degree of relevance is decided by an advertisement delivery device side that delivers the advertisement.
Patent Document 1: Japanese Patent Application Laid-open No. 2007-286833

However, in the above-described content match advertising technique, since a value regarding a degree of relevance is set by the advertisement delivery device, it is difficult for a content providing device side that provides content on which an advertisement is posted to select a value regarding a degree of relevance, and there are cases in which an advertisement which is not desired by a content provider is displayed on content, and thus there is a problem in that a value as content is damaged.

In other words, the content match advertising is a technique of displaying an advertisement relevant to details of content, but how much an advertisement is relevant to content is not controlled by the content providing device side, and an advertisement having a degree of relevance which is equal to or higher than a value regarding a predetermined degree of relevance decided by an advertisement delivery device side is delivered. Thus, for example, there are cases in which an advertisement not having a match degree as high as desired by a content provider is delivered. In this case, there is a problem in that unity as content is damaged. Meanwhile, when advertisements are increasingly delivered without considering unity as content, a profit coming from advertising is likely to increase. In other words, a matched advertisement has unity, but advertisements to be delivered are limited, and thus a profit is likely to decrease. For this reason, when it is difficult for the content providing device side to control a value regarding a degree of relevance between an advertisement and content, it is difficult for the content provider side to control whether to select a profit coming from advertising, select unity as content, or consider a balance of both.

### SUMMARY OF THE INVENTION

It is an object of the present invention to at least partially solve the problems in the conventional technology.

According to one aspect of an embodiment of the present invention, Advertisement delivery device includes: an acquiring unit that acquires a value regarding a degree of relevance with content to which advertisement information set to the content is allowed to be delivered when a delivery request of advertisement information to be delivered to content is received; a calculating unit that calculates a degree of relevance between the content and the advertisement information; a determining unit that determines whether the degree of relevance calculated by the calculating unit is within a range decided by the value regarding the degree of relevance acquired by the acquiring unit; and a delivering unit that delivers the advertisement information as the advertisement information to be delivered to the content when the determining unit that the degree of relevance is determined to be within the range by the determining unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of an advertisement delivery system according to a first embodiment;

FIG. 2 is a block diagram illustrating a configuration of the advertisement delivery system according to the first embodiment;

FIG. 3 is a diagram illustrating an exemplary advertisement table;

FIG. 4 is a diagram illustrating an exemplary tender table;

FIG. 5 is a diagram illustrating an exemplary advertiser table;

FIG. 6 is a diagram illustrating an exemplary screen in which a different degree of relevance is designated for each an advertisement space;

FIG. 7 is a diagram for describing an example of a process of extracting a feature word;

FIG. 8 is a diagram for describing a calculation process and determination process of a degree of relevance;

FIG. 9 is a diagram illustrating an exemplary display screen of content into which an advertisement is inserted;

FIG. 10 is a flowchart illustrating a tender reception process performed by the advertisement delivery device according to the first embodiment;

FIG. 11 is a sequence diagram illustrating an advertisement delivery process performed by the advertisement delivery device according to the first embodiment;

FIG. 12 is a diagram illustrating an example of a list in which a degree of relevance corresponding to an advertisement space is stored; and

FIG. 13 is a diagram illustrating an example of a designation screen of a degree of relevance.

### DETAILED DESCRIPTION OF THE PREFERRED EMBODIMENTS

Hereinafter, modes (hereinafter, referred to as “embodiments”) of carrying out an advertisement delivery device and an advertisement delivery method according to the present application will be described in detail with reference to the appended drawings. An advertisement delivery device and an advertisement delivery method according to the present application are not limited to the following embodiments.

### First Embodiment

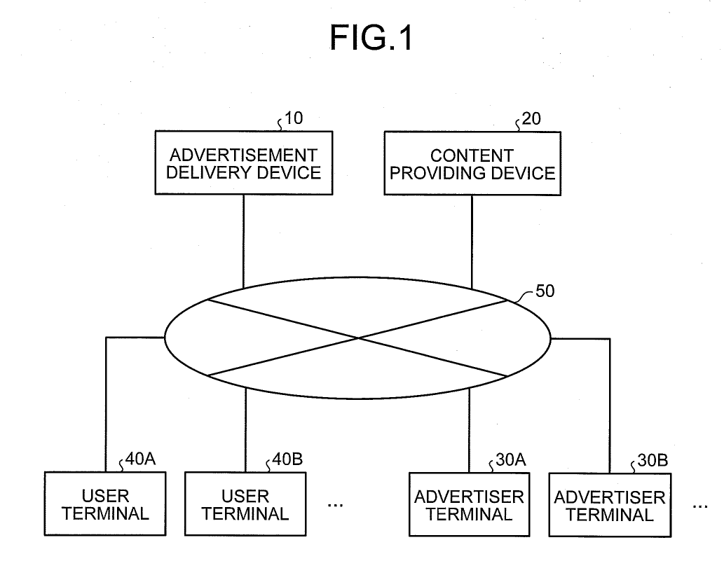

An advertisement delivery device and an advertisement delivery method according to a first embodiment of the present application will be described with reference to FIGS. 1 to 11.

Configuration of Advertisement Delivery System

First of all, a configuration of an advertisement delivery system according to the first embodiment will be described with reference to FIG. 1. FIG. 1 is a block diagram illustrating a configuration of the advertisement delivery system according to the first embodiment.

The advertisement delivery system according to the first embodiment includes an advertisement delivery device 10 serving as an advertisement delivery device, a content providing device 20, a plurality of advertiser terminals 30A and 30B, and a plurality of user terminals 40A and 40B as illustrated in FIG. 1. The advertisement delivery device 10, the content providing device 20, the plurality of advertiser terminals 30A and 30B, and the plurality of user terminals 40A and 40B perform wireless communication or wired communication via a network 50. The advertiser terminals 30A and 30B and the user terminals 40A and 40B are described as an advertiser terminal 30 and a user terminal 40, respectively, when they need not be distinguished from each other.

The advertisement delivery device 10 receives tenders and submissions of advertisements from the plurality of advertiser terminals 30A and 30B. Then, when a request to deliver an advertisement to be placed on content is received from the content providing device 20, the advertisement delivery device 10 acquires an advertisement to be placed on content based on a value regarding a degree of relevance designated by the content providing device 20, and delivers the acquired advertisement to the content providing device 20.

The content providing device 20 provides content in response to a content acquisition request from the user terminal 40, and, for example, provides a web page browse service or the like. For example, when a web page browse request is received from the user terminal 40, the content providing device 20 requests the advertisement delivery device 10 to transmit advertisement information related to details of a corresponding web page, adds the advertisement information acquired from the advertisement delivery device 10 to hyper text markup language (HTML data) data of the web page, and transmits the HTML data of the web page to the user terminals 40A and 40B. Further, when the content acquisition request is transmitted from the user terminal 40 to the content providing device 20, the content acquisition request may be redirected to the advertisement delivery device 10, and an advertisement may be delivered directly from the advertisement delivery device 10 to an advertisement space of content displayed on the user terminal 40.

Further, when transmitting the request to advertisement information to be placed on content information to the advertisement delivery device 10, in order to designate a value regarding a degree of relevance between corresponding content and an advertisement, the content providing device 20 includes a value regarding a degree of relevance with content to which an advertisement is desired to be delivered in a parameter of a redirection URL.

The plurality of advertiser terminals 30A and 30B are advertiser terminals that set an advertisement to be delivered by the advertisement delivery device 10. Specifically, the advertiser terminals 30A and 30B notifies the advertisement delivery device 10 of a setting of a tender price, a setting of advertisement submission, and the like according to the advertiser's operation.

The plurality of user terminals 40A and 40B are terminals that access the content providing device 20 according to the user's operation, acquire HTML data of a web page or the like, and output the web page to a display.

Configuration of Advertisement Delivery Device

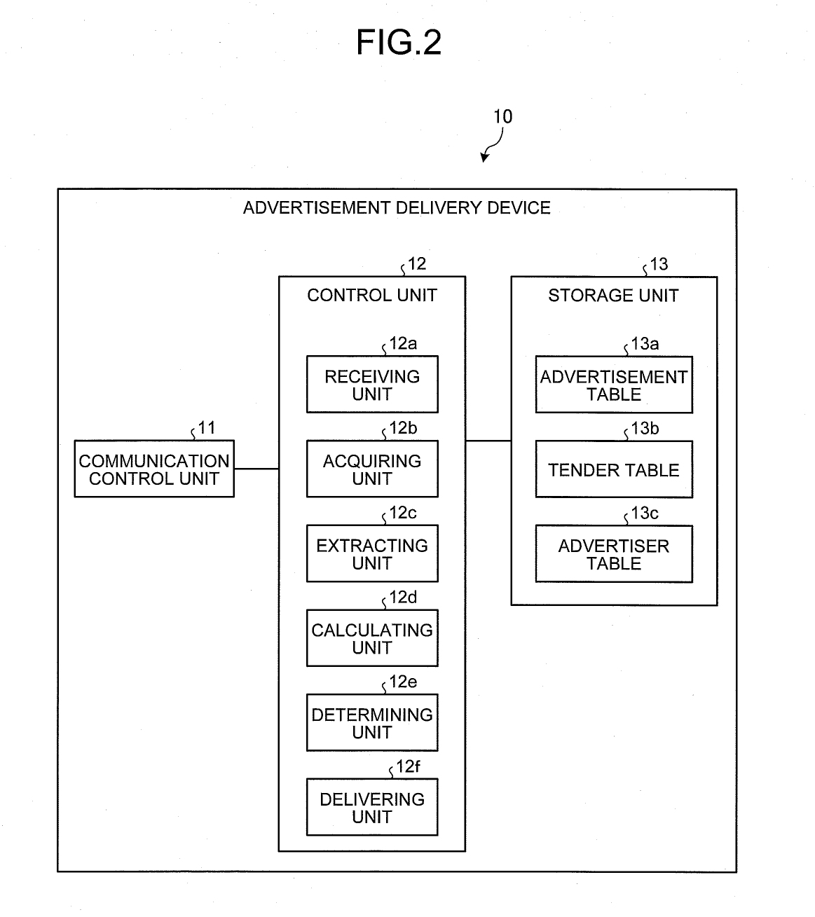

Next, a configuration of the advertisement delivery device 10 will be described with reference to FIG. 2. FIG. 2 is a block diagram illustrating a configuration of the advertisement delivery device according to the first embodiment. The advertisement delivery device 10 includes a communication control unit 11, a control unit 12, and a storage unit 13.

The communication control unit 11 transmits or receives various kinds of data to or from the content providing device 20, the plurality of advertiser terminals 30A and 30B, and the plurality of user terminals 40A and 40B via the network 50. The communication control unit 11 corresponds to, for example, a network card (NIC) or the like.

For example, the storage unit 13 is a semiconductor memory device such as random access memory (RAM) or flash memory or a storage device such as a hard disk or an optical disk. The storage unit 13 stores an advertisement table 13a, a tender table 13b, and an advertiser table 13c.

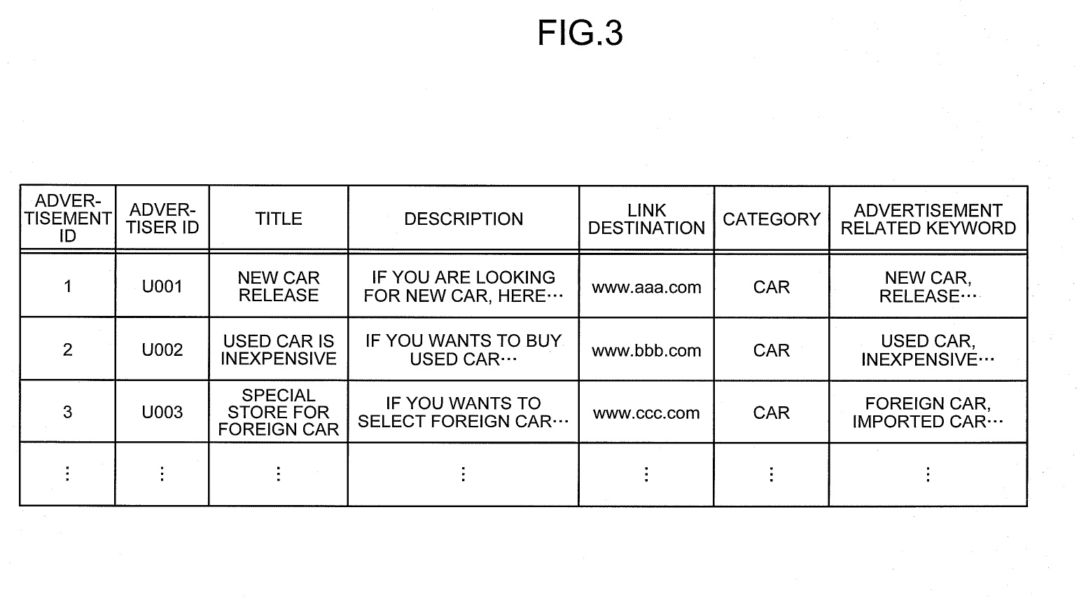

The advertisement table 13a stores information related to an advertisement. For example, the advertisement table 13a stores an “advertisement ID” which is an identifier identifying an advertisement, an “advertiser ID” which is an identifier identifying an advertiser who has submitted an advertisement, a “title” and “description” expressed as a sentence related to an advertisement, a “link destination” which is a URL of a link destination to be set to a displayed advertisement, a “category” representing a category of an advertisement, and an “advertisement related keyword” which is a keyword related to an advertisement in association with one another as illustrated in FIG. 3.

Referring to a concrete example of FIG. 3, the advertisement table 13a stores an advertisement ID “1,” an advertiser ID “U001,” a title “new car release,” a description “if you are looking for a new car, here . . . ,” a link destination “www.aaa.com,” a category “car,” an advertisement related keyword “new car, release, . . . ” in association with one another. Further, the “advertisement ID,” the “advertiser ID,” the “title,” the “description,” the “link destination,” the “category,” and the “advertisement related keyword” are pieces of information which are newly registered each time a submission of an advertisement from the advertiser terminal 30 is received.

The tender table 13b stores information related to a condition for displaying an advertisement. For example, the tender table 13b stores a “tender ID” which is an identifier identifying a tender, an “advertisement ID” which is an identifier identifying an advertisement of a tender target, a “tender price” representing a tender price used as a reference of a price charged each time a click is performed, a “display number (Imps: impression number)” which is the number of times that an advertisement is displayed, a “click number” which is the number of times that an advertising banner is clicked, a “CTR (click number/Imps)” which is a rate of the click number to the number of times that an advertisement is displayed, a “conversion number” which is the number of times until conversion (a final result which can be acquired from content such as a product purchase, a brochure request, or the like) is obtained, and a “CVR (conversion rate)” which is a rate of conversion to the number of times that an advertisement is delivered in association with one another. The advertisement table 13a and the tender table 13b may be integrated into a single table.

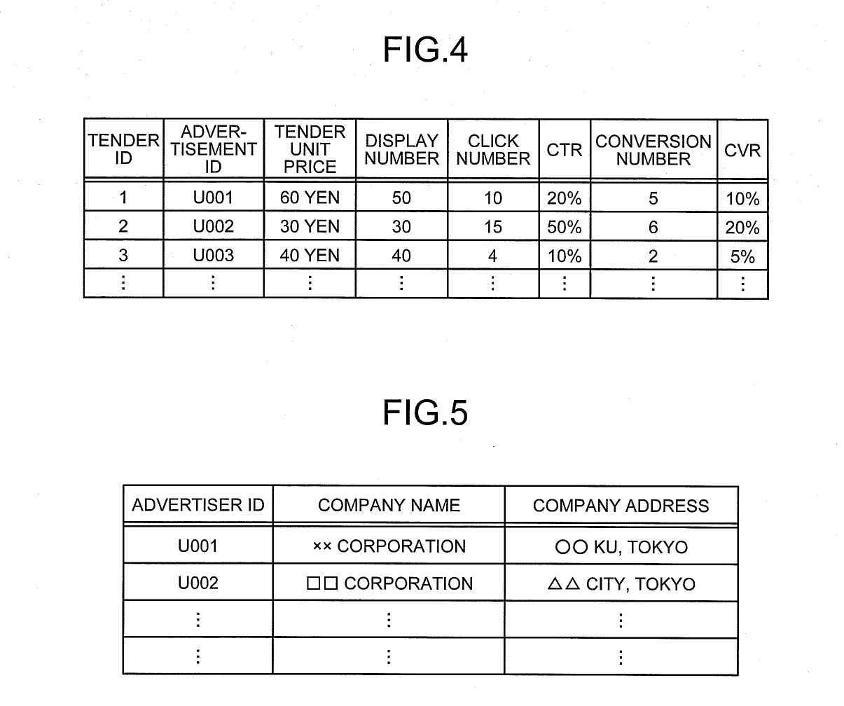

Referring to a concrete example of FIG. 4, the tender table 13b stores a tender ID “1,” an advertiser ID “U001,” a tender unit price “60 yen,” a display number “50,” click number “10,” a CTR “20%,” a conversion number “5,” and a CVR “10%” in association with one another. Further, the “tender ID,” the “advertiser ID,” and the “tender unit price” are pieces of information which are newly registered each time an advertisement tender request is received from the advertiser terminal 30, and the values of the “display number,” the “click number,” the “CTR,” the “conversion number,” and the “CVR” are updated each time an advertisement is delivered.

The advertiser table 13c stores information related to an advertisement. For example, the advertiser table 13c stores a “company name” representing a name of a company which has submitted an advertisement and a “company address” represents an address of a corresponding company in association with each other as illustrated in FIG. 5. Referring to a concrete example of FIG. 5, the advertiser table 13c stores a company name “X X Corporation” and a company address “◯◯ ku, Tokyo” in association with each other. Further, the “advertiser ID,” the “company name,” and the “company address” are pieces of information which are newly registered when an advertiser makes an advertisement tender request for the first time.

The control unit 12 includes a receiving unit 12a, an acquiring unit 12b, an extracting unit 12c, a calculating unit 12d, a determining unit 12e, and a delivering unit 12f. The control unit 12 is implemented as a central processing unit (CPU), a microprocessor unit (MPU), or the like operates according to a computer program which is stored in a storage device in advance.

The receiving unit 12a receives a setting of a tender price, a setting of submission of an advertisement, and the like from the advertiser terminal 30.

Specifically, when the advertisement tender request is received from the advertiser terminal 30, the receiving unit 12a first receives input of advertiser basic information and stores the received advertiser basic information in the advertiser table 13c as an initial setting. For example, the advertiser basic information is formal information such as a company name and a company address. Further, when the advertiser basic information has been input and registered in the past, input of the advertiser basic information may be omitted.

Then, the receiving unit 12a receives information about a tender price which is a price to be paid each time an advertising banner is clicked from the advertiser terminal 30 as a tender unit price for an advertisement, and stores the information about a tender price in the tender table 13b.

For example, when an advertiser sets 10000 yen as a total budget and tenders 100 yen as a click fee, 100 yen is paid to a system operator side each time an advertisement is clicked, and when an advertisement is clicked 100 times and so a paid amount reaches 10000 yen of the total budget, advertisement delivery is stopped.

Then, as submission of an advertisement, the receiving unit 12a receives a title and description displayed as an advertisement, an advertisement related keyword which is a keyword related to an advertisement, and a URL of a link destination to be set to an advertisement to be displayed on content, and stores the received information in the advertisement table 13a. For example, the advertiser inputs a catch phrase or the like as a title of an advertisement, and inputs a description about a product or a service as a description. Further, the advertiser inputs a URL of a web site to be transited when a displayed advertisement is clicked as a link destination. Further, an advertisement which the advertiser desires to deliver is examined, and only an advertisement which has passed the examination starts to be delivered.

When an advertisement delivery request for content is received from the content providing device 20, the acquiring unit 12b acquires a degree of relevance with content to which advertisement information set to the corresponding content is allowed to be delivered. Specifically, when an advertisement delivery request for content is received from the content providing device 20, the acquiring unit 12b acquires a degree of relevance of each advertisement space from a parameter of a redirection URL when an advertising request is made. In other words, the content providing device 20 side can designate a degree of relevance for each advertisement space.

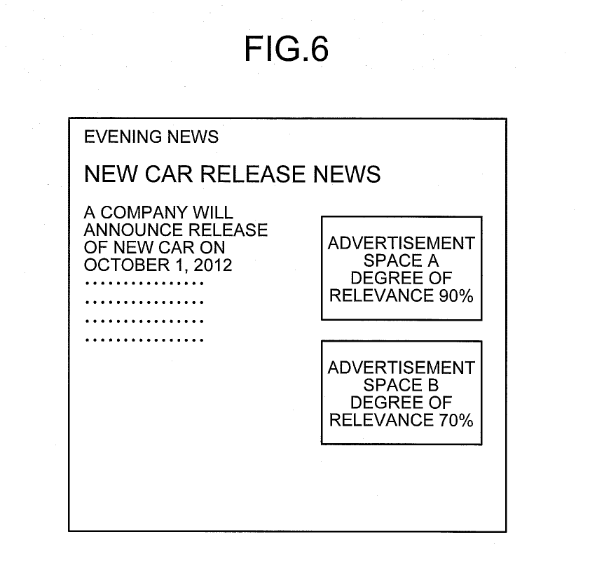

Here, an exemplary screen in which a different degree of relevance is designated for each an advertisement space will be described with reference to FIG. 6. FIG. 6 illustrates an exemplary screen in which a different degree of relevance is designated for each advertisement space. A degree of relevance of “90%” is assumed to be set to an advertisement space A as a parameter of a redirection URL, and a degree of relevance of “70%” is assumed to be set to an advertisement space B as a parameter of a redirection URL as illustrated in FIG. 6. In other words, an advertisement placed in an upper portion of a page which attracts the user's most attention is set to have a high degree of relevance and have a tidy look, and an advertisement placed in a lower portion of a page is set to have a low degree of relevance, induce a click, and increase a profit. Further, an advertisement viewed by scrolling is set to have a lower degree of relevance, further induce a click, and increase a profit, and thus various degrees of relevance can be designated for each advertisement space.

When an advertisement delivery request for content is received from the content providing device 20, the extracting unit 12c extracts a feature word from text information (for example, HTML data) included in corresponding content. Specifically, when HTML data of a web page on which an advertisement is desired to be posted is received from the content providing device 20, the extracting unit 12c extracts a feature word from the HTML data through a known feature extraction algorithm such as term frequency inverse document frequency (TF-IDF).

An exemplary feature word extraction process will be described in detail below. For example, the extracting unit 12c extracts words included in HTML data, and calculates a weighting value for each word. A weighting value is a value representing a degree of relevance between web content and a corresponding word, and is calculated, for example, based on an element which a degree of relevance is calculated based on such as a frequency of appearance, an appearance position, or a text attribute (font data) of a word in the web content. A word which is high in the frequency of appearance in corresponding web content has a meaning directly characterizing the web content, and a word which is positioned at a position representing a title in web content or positioned at the first half of a document has a recapitulative meaning characterizing the corresponding web content. Further, when the text attribute (a font size, a bold text, an underline text, a color text, or the like) is considered, since a web content creator applies a font to a word for some reasons, a meaning characterizing the web content is considered to be similarly reflected.

Further, for a weighting value, how common a corresponding word has been used may be considered. A weighting value may be increased simply according to a hit count of a result of searching a corresponding word through a search engine, or a weighting value may be similarly increased based on a meaning of a word, for example, a proper noun is higher in relevance with a product or the like than a common noun.

As an example of such a weighting, a TF-IDF which is an algorithm (natural language processing) for extracting a feature word in a sentence or the like has been known. A TF-IDF value is obtained based on a TF value representing a frequency of appearance of a word obtained from content and a DF value (or an IDF value which is an inverse frequency of appearance) which is a frequency of appearance obtained as a result of searching a corpus, and a feature word is extracted by extracting a feature word whose TF-IDF value is a threshold value or higher. Here, a corpus is similar to a database including many words, and is assumed to store a frequency of appearance (DF value) of each word. The corpus has a role of decreasing the importance of a common word appearing in many documents and increasing the importance of a word appearing in a certain document only. For example, “all words whose TF-IDF value are a threshold value or higher” or “top N words among words whose TF-IDF value is a threshold value or higher” may be used as the feature word extraction condition. As described above, decision of a word extracted as a feature word can be flexibly made.

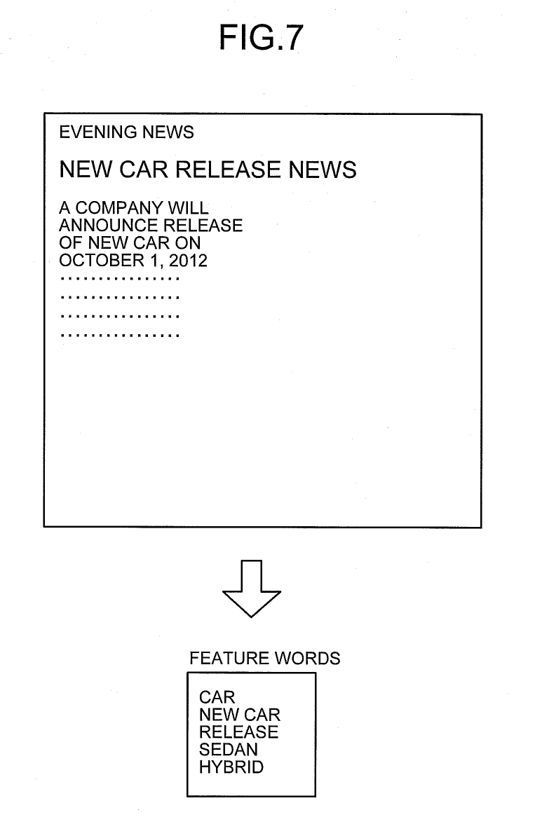

Here, a process of extracting a feature word will be described with reference to a concrete example of FIG. 7. FIG. 7 is a diagram for describing an example of a process of extracting a feature word. For example, when a title “new car release news” and a body text “A company will announce release of a new car on Oct. 1, 2012” are included as an example of web content as illustrated in FIG. 7, words included in HTML data of the corresponding web content are extracted, and a TF-IDF value is calculated for each word. Further, top five words in the descending order of the TF-IDF values, that is “car,” “new car,” “release,” “sedan,” “hybrid” are extracted as feature words.

The calculating unit 12d compares the feature words extracted by the extracting unit 12c with an advertisement related keyword of each advertisement, and calculates a degree of relevance of each piece of advertisement information for content. For example, the calculating unit 12d compares the feature words extracted by the extracting unit 12c with an advertisement related keyword of advertisement information, and calculates a rate of the number of feature words matching the advertisement related keyword to a total number of feature words as a degree of relevance. The process of calculating a degree of relevance is performed for each piece of advertisement information, and a degree of relevance of each piece of advertisement information for content is obtained.

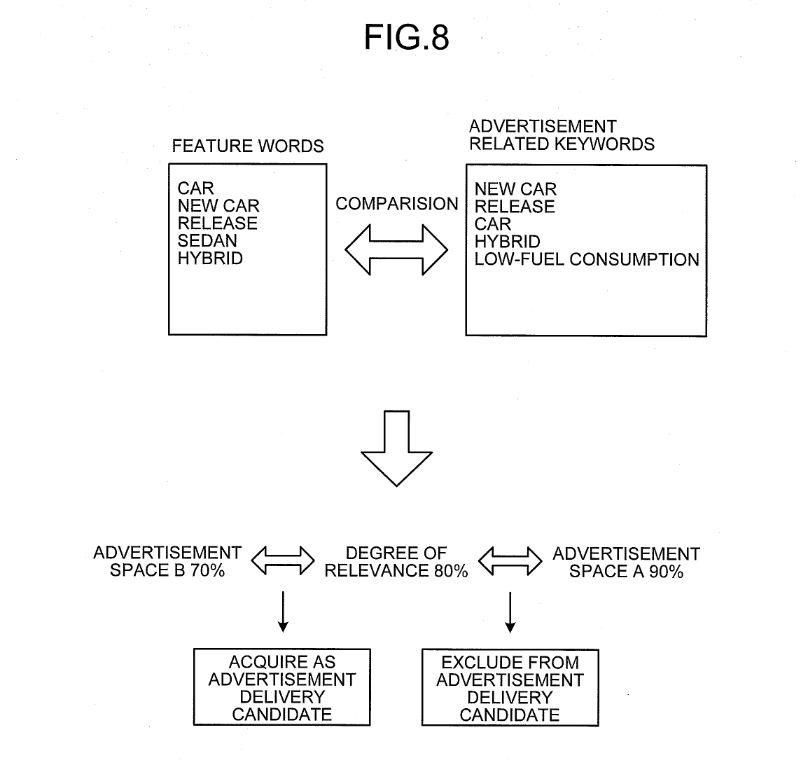

Here, an example of a process of calculating a degree of relevance will be described with reference to FIG. 8. The five feature words, that is, “car,” “new car,” “release,” “sedan,” and “hybrid” are compared with five advertisement related keywords, that is, “new car,” “release,” “car,” “hybrid,” and “low fuel consumption” as illustrated in FIG. 8. As a result, among a total number “5” of feature words, four feature words, that is, “car,” “new car,” “release,” and “hybrid” match the advertisement related keywords, and a degree of relevance is “80%.”

The determining unit 12e determines whether the degree of relevance of each piece of advertisement information calculated by the calculating unit 12d is higher than the degree of relevance acquired by the acquiring unit 12b. For example, in the example of FIG. 8, when the calculated degree of relevance is “80%” and the degree of relevance of the advertisement space A is “90%,” the determining unit 12e determines the calculated degree of relevance “80%” is lower than the degree of relevance “90%” of the advertisement space A, and excludes the corresponding advertisement from an advertisement delivery candidate. Further, when the calculated degree of relevance is “80%” and the degree of relevance of the advertisement space B is “70%,” the determining unit 12e determines the calculated degree of relevance “80%” is higher than the degree of relevance “70%” of the advertisement space B, and acquires corresponding advertisement information as an advertisement delivery candidate.

The delivering unit 12f acquires any one of pieces of advertisement information in which the degree of relevance calculated by the calculating unit 12d is determined as being higher than the degree of relevance acquired by the acquiring unit 12b, and delivers the acquired advertisement information to the content providing device 20. For example, when there are a plurality of pieces of advertisement information in which the degree of relevance calculated by the calculating unit 12d is determined as being higher than the degree of relevance acquired by the acquiring unit 12b, the delivering unit 12f compares values of “tender price×click through rate (CTR)” of respective pieces of advertisement information, selects advertisement information having a larger value of “tender price×click through rate,” and delivers the selected advertisement information to the content providing device 20.

As described above, a degree of relevance of a content match advertisement to be delivered to an advertisement space can be designated at the content providing device 20 side. As described above, the content providing device 20 side can flexibly utilize a service according to each advertisement posting strategy, and thus a service is vitalized.

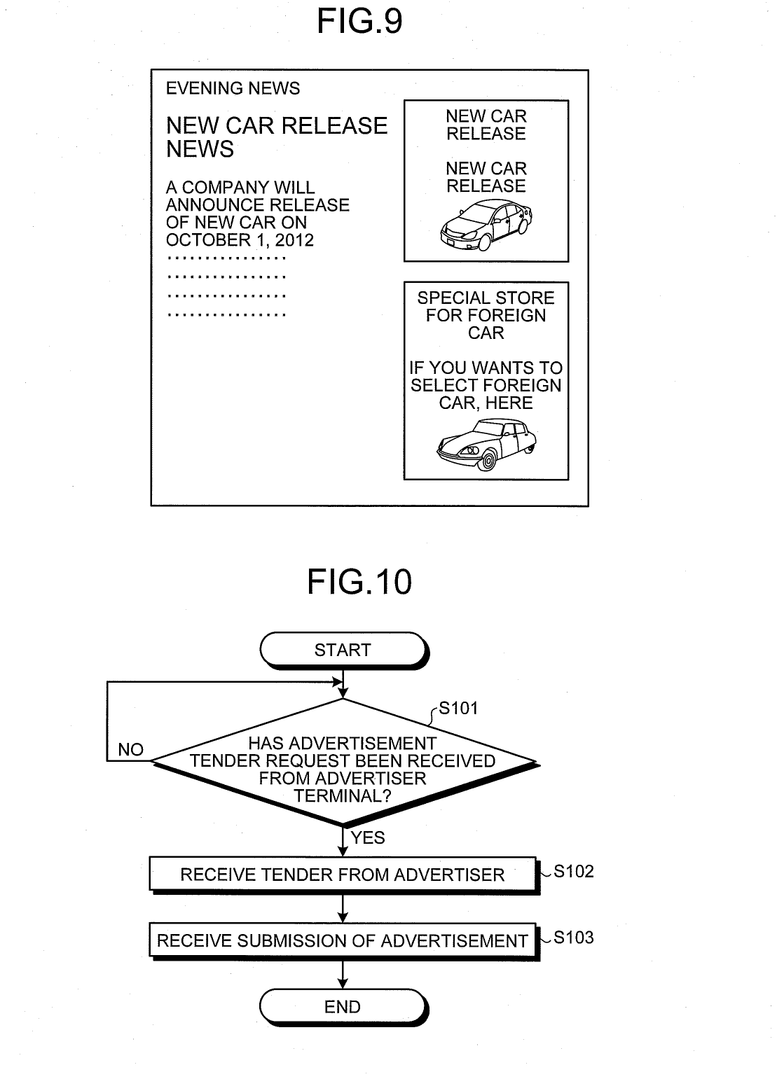

For example, in content of “new car release news,” an advertisement of “new car release” which is high in a degree of relevance is displayed on an advertisement space in an upper portion of a page which attracts the user's most attention to have a tidy look, and an advertisement of “special store for foreign cars” which is slightly low in a degree of relevance is displayed on an advertisement space in a lower portion of a page as illustrated in FIG. 9.

Processing Performed by Advertisement Delivery Device

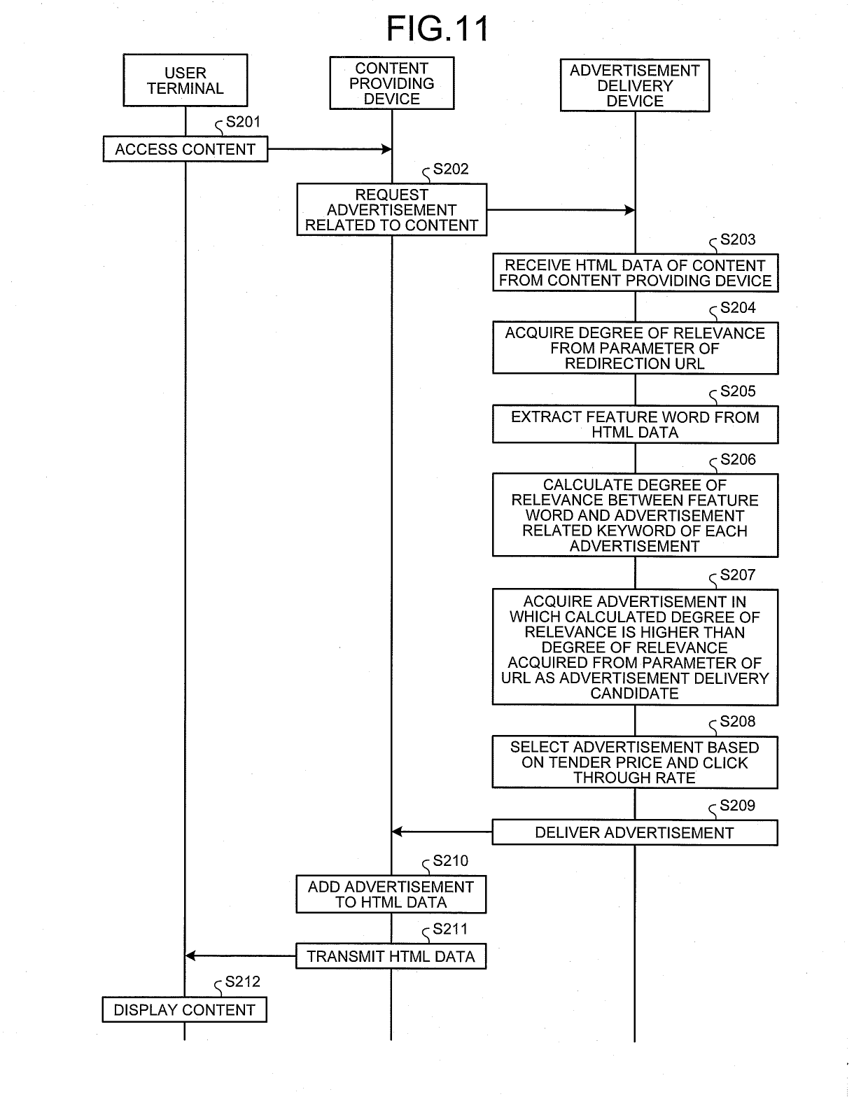

Next, processing performed by the advertisement delivery device 10 according to the first embodiment will be described with reference to FIGS. 10 and 11. FIG. 10 is a flowchart illustrating a tender reception process performed by the advertisement delivery device according to the first embodiment. FIG. 11 is a sequence diagram illustrating an advertisement delivery process performed by the advertisement delivery device according to the first embodiment.

As illustrated in FIG. 10, upon receiving the advertisement tender request from the advertiser terminal (Yes in step S101), the receiving unit 12a of the advertisement delivery device 10 receives a tender from the advertiser terminal 30 (step S102). Specifically, the receiving unit 12a receives information of a price of a click fee which is a price to be paid each time an advertising banner is clicked as a tender unit price for an advertisement from the advertiser terminal 30, and stores the information of the price in the tender table 13b.

For example, when an advertiser sets 10000 yen as a total budget and tenders 100 yen as a click fee, 100 yen is paid to a system operator side each time an advertisement is clicked, and when an advertisement is clicked 100 times and so a paid amount reaches 10000 yen of the total budget, advertisement delivery is stopped.

Then, the receiving unit 12a receives a submission of an advertisement from the advertiser terminal 30 (step S103). Specifically, the receiving unit 12a receives a title and a description displayed as an advertisement and a URL of a link destination set to a displayed advertisement as a submission of an advertisement, and stores the received information in the advertisement table 13a. For example, the advertiser inputs a catch phrase or the like as a title of an advertisement, and inputs a description about a product or a service as a description. Further, the advertiser inputs a URL of a web site to be transited when a displayed advertisement is clicked as a link destination.

Next, the advertisement delivery process performed by the advertisement delivery device 10 will be described with reference to FIG. 11. As illustrated in FIG. 11, the user terminal 40 access content provided by the content providing device 20 according to the user's operation (step S201). Then, when the user's access to the content is received, the content providing device 20 requests the advertisement delivery device 10 to transmit an advertisement related to the corresponding content, and transmits HTML data of a web page to the advertisement delivery device 10 (step S202).

Then, when HTML data of a web page on which an advertisement is desired to be posted is received from the content providing device 20 (step S203), the acquiring unit 12b of the advertisement delivery device 10 acquires a degree of relevance from a parameter of a redirection URL (step S204). Then, the extracting unit 12c of the advertisement delivery device 10 extracts feature words from the HTML data of the web page through a known feature extraction algorithm such as the TF-IDF (step S205).

Then, the calculating unit 12d of the advertisement delivery device 10 compares the feature words extracted by the extracting unit 12c with the advertisement related keywords of each piece of advertisement information, and calculates a degree of relevance of each piece of advertisement information for content (step S206). For example, the calculating unit 12d compares the feature words extracted by the extracting unit 12c with an advertisement related keyword of advertisement information, and calculates a rate of the number of feature words matching the advertisement related keyword to a total number of feature words as a degree of relevance. The process of calculating a degree of relevance is performed for each piece of advertisement information, and a degree of relevance of each piece of advertisement information for content is obtained.

Then, the determining unit 12e of the advertisement delivery device 10 determines whether the degree of relevance of each piece of advertisement information calculated by the calculating unit 12d is higher than the degree of relevance acquired from a parameter of a URL, and acquires an advertisement in which the calculated degree of relevance of each piece of advertisement information is determined as being higher than the degree of relevance acquired from a parameter of a URL as an advertisement delivery candidate (step S207).

Then, the delivering unit 12f of the advertisement delivery device 10 selects an advertisement based on a tender price and a click through rate from among advertisements in which the calculated degree of relevance of each piece of advertisement information is determined as being higher than the degree of relevance acquired from a parameter of a URL (step S208). Specifically, when there are a plurality of pieces of advertisement information in which the calculated degree of relevance is determined as being higher than the degree of relevance acquired from a parameter of a URL, the delivering unit 12f compares values of “tender price×click through rate” of respective pieces of advertisement information, selects advertisement information having a largest value of “tender price×click through rate.” Then, the delivering unit 12f delivers the selected advertisement information to the content providing device 20 (step S209).

Then, when advertisement information is received from the advertisement delivery device 10, the content providing device 20 adds the acquired advertisement information to HTML data of a web page (step S210), and then transmits the HTML data of the web page to the user terminals 40A and 40B (step S211). Then, the user terminal 40 acquires the HTML data of the web page and the like, and displays the web page on the display (step S212).

### Effects of First Embodiment

As described above, when a delivery request of advertisement information to be added to content is received, the advertisement delivery device 10 acquires a degree of relevance with content to which advertisement information set to the corresponding content is allowed to be delivered, calculates a degree of relevance between the content and the advertisement information, determines whether the calculated degree of relevance is higher than the acquired degree of relevance, and delivers the corresponding advertisement information as advertisement information to be added to the content when the calculated degree of relevance is determined as being higher than the acquired degree of relevance. As described above, as a degree of relevance of a content match advertisement to be delivered to an advertisement space can be designated at the content providing device 20 side, for example, since an advertisement which is not beautiful to the user's eye such as a spam advertisement is prevented from being displayed, it is possible to prevent a value as content from being damaged, and advertisements to be delivered are increased without considering unity between an advertisement and content, and thus a profit coming from an advertisement can be increased. As a result, the content providing device 20 side can flexibly utilize a service according to each advertisement posting strategy, and thus a service is vitalized.

Further, according to the first embodiment, the advertisement delivery device 10 extracts a feature word from text information included in content to which advertisement information is added, compares the extracted feature word with an advertisement related keyword corresponding to the stored advertisement information, and calculates a degree of relevance. Thus, the advertisement delivery device 10 can appropriately calculate a degree of relevance and appropriately select advertisement information to be delivered using a degree of relevance designated by the advertiser.

Furthermore, according to the first embodiment, since the advertisement delivery device 10 acquires a degree of relevance set to each advertisement space included in content, the content providing device 20 side can set a degree of relevance for each advertisement space.

### Second Embodiment

The first embodiment of the present invention has been described above, but the present invention can be implemented through various embodiments in addition to the above-described embodiment. In this regard, another embodiment included in the present invention will be described below as a second embodiment.

(1) Provision of Tendency of Degrees of Relevance of Other Content Items

In the present invention, degrees of relevance set by other content providing devices that provide the similar content items as content provided by the content providing device may be aggregated, and a setting tendency of a degree of relevance may be provided. For example, the advertisement delivery device may obtains an average of degrees of relevance designated by other content providing devices that provide content of the similar category and provide the average value to the content providing device as a setting tendency of a degree of relevance.

As described above, the advertisement delivery device aggregates degrees of relevance set by other content providing devices that provide the similar content items as content provided by the content providing device, and provides a setting tendency of a degree of relevance. Thus, the content providing device side can decide a degree of relevance with reference to the tendency of a degree of relevance designated by other content providing devices that provide content items of the similar category.

(2) Provision of Tendency of Degrees of Relevance of Other Content Items

The first embodiment has been described in connection with the example in which a degree of relevance is included in a parameter of a redirection URL, but the present invention is not limited to this example, and the advertisement delivery device side may store a degree of relevance list previously notified from the content providing device side.

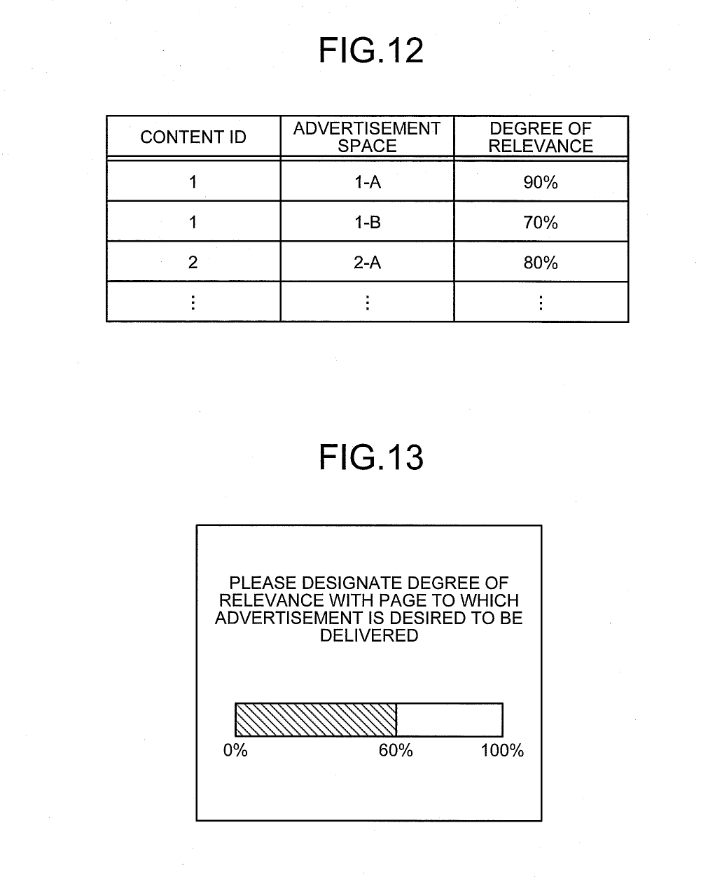

For example, advertisement delivery device stores a list in which a “content ID” identifying content, an “advertisement space” identifying an advertisement space included in content, and a “degree of relevance” which is a degree of relevance set to a corresponding advertisement space in association with one another as a degree of relevance list previously notified from the content providing device side as illustrated in FIG. 12.

(3) Setting by Slide Bar

In the present invention, as a degree of relevance set at the content providing device side, an arbitrary value of a degree of relevance may be input, or an arbitrary value of a degree of relevance may be selected by a slide bar.

For example, the advertisement delivery device causes the content providing device to display a message “please designate a degree of relevance with a page in which an advertisement is desired to be delivered,” causes a slide bar to be displayed, causes a desired value of a degree of relevance to be selected using a slide bar at the content providing device side, and receives a value of a degree of relevance as illustrated in FIG. 13.

As described above, a value of a degree of relevance is designated by a slide bar displayed at the content providing device side. Thus, the advertiser can finely set a degree of relevance using the slide bar.

(4) Determination Process

The first embodiment has been described in connection with that it is determined whether a calculated degree of relevance of each piece of advertisement information is higher than a degree of relevance corresponding to each piece of advertisement information stored in a storage unit as a process of deciding whether an advertisement is to be delivered, but the present invention is not limited to this example. For example, a predetermined range (for example, 50 to 70) may be stored in a storage unit as a degree of relevance corresponding to advertisement information, and it may be determined whether a calculated degree of relevance of each piece of advertisement information is within a range decided by a degree of relevance corresponding to each piece of advertisement information stored in a storage unit. Further, it may be determined whether a reciprocal of a degree of relevance corresponding to each piece of advertisement information is a value of a degree of relevance or less.

(5) Others

Further, a configuration of the advertisement delivery device 10 can be flexibly changed, and for example, the advertisement delivery device 10 may be implemented by a plurality of sever computers or may be implemented by calling an external platform or the like through an application programming interface (API) or network computing, or the like according to a function.

Further, the term “means” set forth in the appended claims can be interpreted as a “portion (section, module, or unit),” a “circuit,” or the like. For example, an extracting means can be interpreted as an extracting unit or an extracting circuit.

According to an advertisement delivery device and an advertisement delivery method of the present application, the content provider can designate a value regarding a degree of relevance between an advertisement and content, and thus there is an effect that the content provider side can control whether to select a profit coming from advertising or unity as content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery device, comprising:
an acquiring unit that acquires a value regarding a degree of relevance with content to which advertisement information set to the content is allowed to be delivered when a delivery request of advertisement information to be delivered to content is received;
a calculating unit that calculates a degree of relevance between the content and the advertisement information;
a determining unit that determines whether the degree of relevance calculated by the calculating unit is within a range decided by the value regarding the degree of relevance acquired by the acquiring unit; and
a delivering unit that delivers the advertisement information as the advertisement information to be delivered to the content when the determining unit that the degree of relevance is determined to be within the range by the determining unit.

2. The advertisement delivery device according to claim 1, further comprising:
a storage unit that stores a related word which is a word relevant to each piece of advertisement information for each piece of advertisement information; and
an extracting unit that extracts a feature word from text information included in the content to which the advertisement information is to be delivered,
wherein the calculating unit compares the feature word extracted by the extracting unit with the related word corresponding to the advertisement information stored in the storage unit, and calculates the degree of relevance.

3. The advertisement delivery device according to claim 1,
wherein the acquiring unit acquires a value regarding a degree of relevance set for each advertisement space included in the content.

4. The advertisement delivery device according to any one of claim 1,
wherein values regarding a degree of relevance set by other content providing devices that provide the similar content as content provided by a content providing device are aggregated, and a setting tendency of a value regarding a degree of relevance is provided.

5. The advertisement delivery device according to any one of claim 1, further comprising,
a receiving unit that receives a value regarding the degree of relevance designated by a slide bar displayed at a content providing device that provides content.

6. A response generating method which is executed by an advertisement delivery device, comprising:
acquiring a value regarding a degree of relevance with content to which advertisement information set to the content is allowed to be delivered when a delivery request of advertisement information to be delivered to content is received;
calculating a degree of relevance between the content and the advertisement information;
determining whether the degree of relevance calculated by the calculating is within a range decided by the value regarding the degree of relevance acquired by the acquiring unit; and
delivering the advertisement information as the advertisement information to be delivered to the content when the degree of relevance is determined as being within the range by the determining.
